(19) United States
(12) Patent Application Publication
(10) Pub. No.: US 2025/0274908 A1
(43) Pub. Date: Aug. 28, 2025

(54) METHOD AND DEVICE FOR TRANSMITTING OR RECEIVING DATA THROUGH SIDELINK IN WIRELESS COMMUNICATION SYSTEM

(71) Applicant: HANBAT NATIONAL UNIVERSITY INDUSTRY-ACADEMIC COOPERATION FOUNDATION, Daejeon (KR)

(72) Inventor: Eunkyung KIM, Daejeon (KR)

(21) Appl. No.: 18/858,317

(22) PCT Filed: Mar. 8, 2023
(86) PCT No.: PCT/KR2023/003145

§ 371 Date: Oct. 21, 2024

(30) Foreign Application Priority Data
Apr. 20, 2022 (KR) 10-2022-0048818
Apr. 20, 2022 (KR) 10-2022-0048820

(51) Int. Cl. H04W 72/02; H04L 5/00; H04W 24/10; H04W 72/25; H04W 92/18

(52) U.S. Cl. CPC H04W 72/02; H04L 5/0048; H04W 24/10; H04W 72/25; H04W 92/18

(57) ABSTRACT

The present specification provides a method for transmitting or receiving data between a first terminal and a second terminal through a sidelink in a wireless communication system. More specifically, the method performed by the second terminal is performed by including the stages of: receiving sidelink control information (SCI) including a channel state information (CSI) request field indicating a CSI request from the first terminal on a physical sidelink shared channel (PSSCH); receiving a CSI-RS from the first terminal on the PSSCH; measuring a channel state of a sidelink based on the received CSI-RS; checking whether there is data to be transmitted to the first terminal at a time point at which CSI reporting including the measured channel state is to be transmitted; and determining whether to transmit the CSI reporting based on a result of the identification. Accordingly, unnecessary power consumption of a terminal can be reduced.

### CROSS-REFERENCE TO RELATED APPLICATIONS

This application is the National Stage filing under 35 U.S.C. 371 of International Application No. PCT/KR2023/003145, filed on Mar. 8, 2023, which claims the benefit of KR Applications No. 10-2022-0048818 and No. 10-2022-0048820 filed on Apr. 20, 2022, the contents of which are all hereby incorporated by reference herein in their entirety.

### TECHNICAL FIELD

The present specification relates to a wireless communication system, and more particularly, to a method for transmitting or receiving data through a sidelink and a device supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as dual connectivity, massive multiple-input, multiple-output (MIMO), in-band full duplex, non-orthogonal multiple access (NOMA), supporting super-wide band, and device networking, have been researched.

### DETAILED DESCRIPTION OF INVENTION

### Technical Problems

An aspect of the present specification is directed to providing a method for transmitting CSI reporting in a wireless communication system supporting a sidelink.

In addition, an aspect of the present specification is directed to defining priorities with other data when MAC CE including CSI reporting and MAC SDU including data are transmitted together.

In addition, an aspect of the present specification is directed to providing a method for transmitting or receiving data in a sidelink by considering preferred resources or non-preferred resources.

The technical tasks of the present disclosure are not limited to those mentioned above, and other technical tasks not mentioned may be clearly understood by those skilled in the art from the following description.

### Technical Solution

The present specification relates to a method for transmitting or receiving data between a first terminal and a second terminal through a sidelink in a wireless communication system, wherein the method performed by the second terminal includes: receiving sidelink control information (SCI) including a channel state information (CSI) request field indicating a CSI request from the first terminal on a physical sidelink shared channel (PSSCH); receiving a CSI-RS from the first terminal on the PSSCH; measuring a channel state of the sidelink on the basis of the received CSI-RS; identifying whether there is data to be transmitted to the first terminal at a time point at which CSI reporting including the measured channel state is to be transmitted; and determining whether to transmit the CSI reporting on the basis of a result of the identification.

In addition, in the present specification, the method further includes: transmitting, to the first terminal, a MAC protocol data unit (PDU) including a MAC control element (CE) including the CSI reporting and a MAC service data unit (SDU) including data to be transmitted to the first terminal, when there is data to be transmitted to the first terminal.

In addition, the present specification is characterized in that, when there is no data to be transmitted to the first terminal, the MAC PDU including the MAC CE including the CSI reporting is transmitted to the first terminal, but the MAC PDU does not include the MAC SDU including the data.

In addition, in the present specification, the method further includes: transmitting, to the first terminal, the MAC PDU including the MAC CE including the CSI reporting and the MAC SDU padded to a certain size, when there is no data to be transmitted to the first terminal.

In addition, in the present specification, the certain size is a size of the PSSCH.

In addition, in the present specification, when there is no data to be transmitted to the first terminal, the CSI reporting is not transmitted to the first terminal.

In addition, in the present specification, the method further includes receiving higher layer signaling that triggers an inter-UE coordination operation from a base station, wherein the higher layer signaling includes control information related to determination of a preferred or non-preferred resource set.

In addition, in the present specification, the method further includes: performing resource sensing based on the higher layer signaling; determining a sidelink resource set including at least one of a preferred resource set or a non-preferred resource set based on a result of the resource sensing; transmitting information related to the determined sidelink resource set to the first terminal; and receiving the data on the PSSCH through a sidelink resource from the first terminal.

In addition, in the present specification, the sidelink resource is a preferred resource transmitted by multiple terminals or a preferred resource transmitted by a small number of terminals.

In addition, in the present specification, the data received on the PSSCH through the sidelink resource is groupcast data transmitted to a terminal group or broadcast data transmitted to a plurality of terminals.

In addition, in the present specification, the sidelink resource is a preferred resource transmitted by multiple terminals or a non-preferred resource transmitted by a small number of terminals.

In addition, in the present specification, the method further includes: receiving a retransmission request for the CSI reporting from the first terminal; and performing retransmission related to the CSI reporting to the first terminal.

In addition, in the present specification, the retransmission related to the CSI reporting is configured to transmit the MAC PDU including the MAC CE and the MAC SDU including the CSI reporting, transmit the MAC PDU including the MAC CE including the CSI reporting but not including the MAC SDU, or transmit the MAC PDU including the MAC SDU but not including the MAC CE including the CSI reporting.

In addition, the present specification provides a method for transmitting or receiving data between a first terminal and a second terminal through a sidelink in a wireless communication system, wherein the second terminal includes: a radio frequency (RF) module for transmitting or receiving a radio signal; and a processor functionally connected to the RF module, and wherein the processor is controlled to: receive sidelink control information (SCI) including a channel state information (CSI) request field indicating a CSI request from the first terminal on a physical sidelink shared channel (PSSCH); receive a CSI-RS from the first terminal on the PSSCH; measure a channel state of the sidelink on the basis of the received CSI-RS; identify whether there is data to be transmitted to the first terminal at a time point at which CSI reporting including the measured channel state is to be transmitted; and determine whether to transmit the CSI reporting on the basis of a result of the identification.

### Effect of Invention

The present specification can reduce unnecessary power consumption of a terminal by performing CSI reporting while considering whether there is data to be transmitted to a terminal performing the CSI reporting.

In addition, the present specification can reduce unnecessary power consumption of a terminal by considering sidelink resource set information transmitted from other terminals when resources are selected for data transmission through a sidelink.

The benefits of the present disclosure are not limited to those mentioned above, and other benefits not mentioned may be clearly understood by those skilled in the art from the following description.

### BRIEF DESCRIPTION OF THE DRAWING

In order to help understanding of the present disclosure, the accompanying drawings which are included as a portion of the detailed description provide embodiments of the present disclosure and describe the technical features of the present disclosure together with the detailed description.

FIG. 1 is a diagram illustrating the types of V2X applications to which the method proposed in the present specification may be applied.

FIG. 2 is a diagram illustrating an example of an operation method of a terminal according to a resource allocation mode in a sidelink.

FIG. 3 is a diagram illustrating an example of sidelink resource allocation mode 1 to which the method proposed in the present specification may be applied.

FIG. 4 is a diagram illustrating an example of sidelink resource allocation mode 2 to which the method proposed in the present specification may be applied.

FIG. 5 is a diagram illustrating an example of a control channel and a data channel in a sidelink to which the method proposed in the present specification may be applied.

FIG. 6 is a diagram illustrating an example of a sidelink CSI reporting method to which the method proposed in the present specification may be applied.

FIG. 7 is a diagram illustrating an example of a SL-SCH subheader, MAC subPDU, and MAC CE structure within a PSSCH to which the method proposed in the present specification may be applied.

FIG. 8 is a flowchart showing an example of a method for selecting resources for data transmission in a sidelink proposed in the present specification.

FIG. 9 is a flowchart showing an example of an operation method of a terminal for performing the method proposed in the present specification.

FIG. 10 shows an example of an internal block diagram of the device proposed in the present specification.

### BEST MODE FOR CARRYING OUT THE INVENTION

In what follows, preferred embodiments according to the present disclosure will be described in detail with reference to appended drawings. The detailed descriptions provided below together with appended drawings are intended only to explain illustrative embodiments of the present disclosure, which should not be regarded as the sole embodiments of the present disclosure. The detailed descriptions below include specific information to provide complete understanding of the present disclosure. However, those skilled in the art will be able to comprehend that the present disclosure may be embodied without the specific information.

For some cases, to avoid obscuring the technical principles of the present disclosure, structures and devices well-known to the public may be omitted or may be illustrated in the form of block diagrams utilizing fundamental functions of the structures and the devices.

Abase station in the present specification is regarded as a terminal node of a network, which performs communication directly with a terminal. In this document, particular operations regarded to be performed by the base station may be performed by an upper node of the base station depending on situations. In other words, it is apparent that in a network consisting of a plurality of network nodes including the base station, various operations performed for communication with the terminal may be performed by the base station or by network nodes other than the base station. The term “base station (BS)” may be replaced with a fixed station, Node B, evolved-NodeB (eNB), base transceiver system (BTS), access point (AP), or general NB (gNB). In addition, the terminal may be fixed or mobile; and the term may be replaced with user equipment (UE), mobile station (MS), user terminal (UT), mobile subscriber station (MSS), subscriber station (SS), advanced mobile station (AMS), wireless terminal (WT), machine-type communication (MTC) device, machine-to-machine (M2M) device, or device-to-device (D2D) device.

In what follows, downlink (DL) refers to communication from the base station to a terminal, while uplink (UL) refers to communication from a terminal to the base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present disclosure, and the specific terms may be used in different ways as long as it does not leave the technical scope of the present disclosure.

The technology described below may be used for various types of wireless access systems based on code division multiple access (CDMA), frequency division multiple access (FDMA), time division multiple access (TDMA), orthogonal frequency division multiple access (OFDMA), single carrier frequency division multiple access (SC-FDMA), or non-orthogonal multiple access (NOMA). CDMA may be implemented by such radio technology as universal terrestrial radio access (UTRA) or CDMA2000. TDMA may be implemented by such radio technology as global system for mobile communications (GSM), general packet radio service (GPRS), or enhanced data rates for GSM evolution (EDGE). OFDMA may be implemented by such radio technology as the IEEE 802.11 (Wi-Fi), the IEEE 802.16 (WiMAX), the IEEE 802-20, or evolved UTRA (E-UTRA). UTRA is part of the universal mobile telecommunications system (UMTS). The 3rd generation partnership project (3GPP) long term evolution (LTE) is part of the evolved UMTS (E-UMTS) which uses the E-UTRA, employing OFDMA for downlink and SC-FDMA for uplink transmission. The LTE-A (Advanced) is an evolved version of the 3GPP LTE system.

5G new radio (NR) defines enhanced mobile broadband (eMBB), massive machine type communications (mMTC), ultra-reliable and low latency communications (URLLC), and vehicle-to-everything (V2X) based on usage scenario.

In addition, a 5G NR standard is divided into standalone (SA) and non-standalone (NSA) depending on co-existence between a NR system and a LTE system.

In addition, the 5G NR supports various subcarrier spacings and supports CP-OFDM in the downlink and CP-OFDM and DFT-s-OFDM (SC-OFDM) in the uplink.

Embodiments of the present disclosure may be supported by standard documents described in at least one of wireless access systems including the IEEE 802, 3GPP, and 3GPP2 specifications. In other words, stages or parts in the embodiments of the present disclosure which are not described to clearly show the technical spirit of the present disclosure may be supported by the documents above. In addition, all of the terms described in this document may be explained with reference to the standard documents.

To clarify the descriptions, this document is described based on 3GPP LTE/LTE-A/NR (New Radio), but the technical features of the present disclosure are not limited thereto.

### Vehicle-to-Everything (V2X) Communication

Hereinafter, V2X communication applicable to the method proposed in the present specification will be described.

The V2X communication includes communication between a vehicle and all entities such as vehicle-to-vehicle (V2V) referring to communication between vehicles, vehicle-to-infrastructure (V2I) referring to communication between a vehicle and an eNB or a road side unit (RSU), and vehicle-to-pedestrian (V2P) or a vehicle-to-network (V2N) referring to communication between a vehicle and the terminal owned by an individual (a pedestrian, bicycler, vehicle driver, or passenger).

The V2X communication may represent the same meaning as V2X sidelink or NR V2X, or may include a broader meaning including the V2X sidelink or NR V2X.

For example, the V2X communication may be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication may be provided via a PC5 interface and/or a Uu interface. In this connection, in a wireless communication system that supports the V2X communication, there may exist a specific network entity for supporting the communication between the vehicle and all the entities. For example, the network entity may be a base station (eNB), the RSU[⁰|1], a terminal, or an application server (for example, a traffic safety server), or the like.

In addition, the terminal performing the V2X communication may refer to not only a general handheld terminal (handheld UE) but also a vehicle terminal (V-UE), a pedestrian terminal (pedestrian UE), a base station type (eNB type) RSU, a terminal type (UE type) RSU, a robot having a communication module, or the like.

The V2X communication may be performed directly between terminals or may be performed through the network entities. V2X operation modes may be divided according to a method for performing the V2X communication.

Terms used in the V2X communication are defined as follows.

Road Side Unit (RSU): The RSU is a V2X serviceable device that may perform transmission/reception with a moving vehicle using a V2I service.

Furthermore, the RSU may exchange messages with other entities supporting the V2X application as a fixed infrastructure entity supporting the V2X application.

Pseudonymity: Conditions under which personally identifiable information (PII) is processed such that the data may no longer be provided to a specific subscriber without the use of additional pieces of information, provided that such additional pieces of information are kept separately and there are technical and organizational measures to ensure non-attribution to an identified or identifiable subscriber.

The RSU is a term often used in the existing ITS specifications, and a reason for introducing this term in 3GPP specifications is to make it easy to read a document in an ITS industry.

The RSU is a logical entity that combines a V2X application logic with functions of an eNB (referred to as eNB-type RSU) or a UE (referred to as UE-type RSU).

V2I service: A type of V2X service in which one is a vehicle and the other is an entity belonging to an infrastructure.

V2P service: A V2X service type in which one is a vehicle and the other is a device (for example, handheld terminal carried by a pedestrian, bicycler, driver, or passenger) carried by an individual.

V2X service: A 3GPP communication service type in which a transmission or reception device is related to a vehicle.

Depending on the counterparty participating in the communication, it may be further divided into V2V service, V2I service, and V2P service.

V2X enabled UE: A UE supporting the V2X service.

V2V service: A type of the V2X service in which both sides of communication are vehicles.

V2V communication range: A direct communication range between two vehicles participating in the V2V service.

### V2X Application Support Type

The V2X application referred to as the V2X (vehicle-to-everything) includes four types such as (1) vehicle-to-vehicle (V2V), (2) vehicle-to-infrastructure (V2I), (3) vehicle-to-network (V2N), and (4) vehicle-to-pedestrian (V2P).

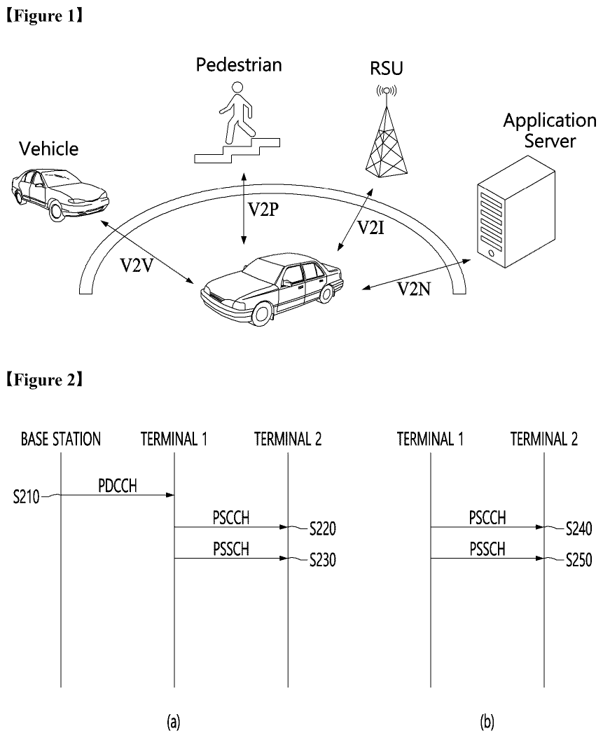

FIG. 1 illustrates a type of V2X application.

These four types of V2X applications may use “co-operative awareness” to provide more intelligent services for end users.

This refers to collecting knowledge (for example, information received from an adjacent other vehicle or sensor equipment) regarding a corresponding area environment for entities such as a vehicle, a road-based facility, an application server, and a pedestrian to process and share the corresponding knowledge to provide intelligent information such as cooperation collision warning or autonomous driving.

These intelligent transport services and related message sets are defined in automotive standards developing organizations (SDOs) outside 3GPP.

Three basic classes for providing ITS services: road safety, traffic efficiency and other applications are described in, for example, ETSI TR 102 638 V1.1.1: “Vehicular Communications; Basic Set of Applications; Definitions.”

The 3GPP processes only the transmission of these messages to support various types of V2X applications.

### Sidelink Resource Allocation

A resource allocation method or resource allocation mode in a sidelink will be described.

The terminal is configured with one or more sidelink resource pools through higher layer signaling. The sidelink resource pool is intended to transmit a PSSCH or receive the PSSCH and may be associated with sidelink resource allocation mode 1 or sidelink resource allocation mode 2.

In a frequency domain, the sidelink resource pool is configured of consecutive subchannels, which are indicated by a sl-NumSubchannel field. The subchannel is configured of consecutive PRBs, and the consecutive PRBs are indicated by the sl-SubchannelSize field. Herein, sl-NumSubchannel and sl-SubchannelSize are higher layer parameters.

FIG. 2 is a diagram illustrating an example of an operation method of a terminal according to a resource allocation mode in a sidelink.

More specifically, FIG. 2A illustrates a terminal operation related to sidelink resource allocation mode 1, and FIG. 2B illustrates a terminal operation related to sidelink resource allocation mode 2.

For sidelink resource allocation mode 1, the base station may schedule sidelink resources to be used by the terminal for sidelink transmission.

The base station performs resource scheduling to terminal 1 through PDCCH (more specifically, DCI), and terminal 1 performs sidelink communication with terminal 2 according to the resource scheduling. Terminal 1 may transmit SCI (sidelink control information) to terminal 2 through a physical sidelink control channel (PSCCH), and then transmit data based on the SCI through a physical sidelink shared channel (PSSCH).

Control information that the base station transmits to the terminal through the PDCCH may be called downlink control information (DCI), whereas control information that the terminal transmits to another terminal through the PSCCH may be called the SCI. The SCI may convey sidelink scheduling information. The SCI may have several formats, for example, there may be SCI format 1 and SCI format 2.

Referring to FIG. 2A, in sidelink resource allocation mode 1, the base station performs resource scheduling to terminal 1 through the PDCCH (more specifically, DCI) (S210), and terminal 1 performs sidelink with terminal 2 according to the resource scheduling. Terminal 1 may transmit the SCI to terminal 2 through the PSCCH (S220), and then transmit data based on the SCI through the PSSCH (S230).

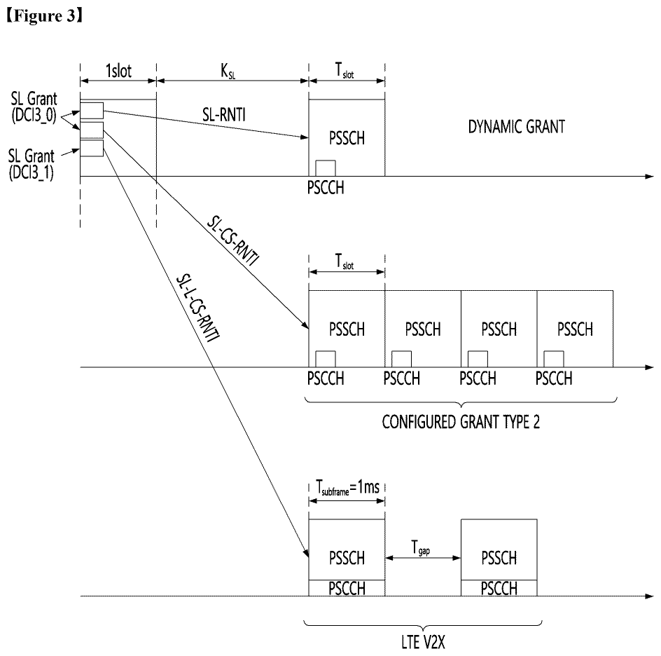

FIG. 3 is a diagram illustrating an example of sidelink resource allocation mode 1 to which the method proposed in the present specification may be applied.

Referring to FIG. 3, in sidelink resource allocation mode 1, dynamic grant, configured grant type 1, and configured grant type 2 are supported for PSSCH and PSCCH transmission. The sidelink transmissions of configured grant type 2 are semi-persistently scheduled by an SL grant in a valid active DCI.

The terminal transmits the PSSCH in the same slot as the associated PSCCH, and the minimum resource allocation unit in a time domain is a slot.

In addition, the terminal transmits the PSSCH as consecutive symbols within a slot, subject to the following restrictions:
The terminal does not transmit the PSSCH in symbols that are not configured for a sidelink, and within a slot, PSSCH resource allocation starts from an Sl-StartSymbol+1 symbol, and the terminal does not transmit the PSSCH in the last symbol configured for the sidelink.

In addition, for sidelink dynamic grant, PSSCH transmission is scheduled by DCI format 3_0, and for sidelink configured grant type 2, the configured grant is activated by DCI format 3_0.

K_{SL} represents a slot offset between a slot of the DCI and the first sidelink transmission scheduled by the DCI, and Tₛₗₒₜ represents the SL slot duration.

In addition, in the frequency domain, the sidelink resource allocation unit is a sub-channel. Sub-channel allocation for sidelink transmission is determined using a frequency resource assignment field in the associated SCI.

The lowest sub-channel of the sidelink transmission is the sub-channel on which the lowest PRB of the associated PSCCH is transmitted.

Referring to FIG. 2B, in the case of sidelink resource allocation mode 2, the terminal may determine sidelink transmission resources within the sidelink resources configured by the base station (or network) or within the pre-configured sidelink resources. The configured sidelink resources or pre-configured sidelink resources may be a resource pool. For example, in sidelink resource allocation mode 2, the terminal may autonomously select sidelink resources for transmission. For example, in sidelink resource allocation mode 2, the terminal may assist in sidelink resource selection for another terminal. For example, in sidelink resource allocation mode 2, the terminal may be set up with an NR configured grant for sidelink transmission. For example, in sidelink resource allocation mode 2, the terminal may schedule sidelink transmission of another terminal. In addition, sidelink resource allocation mode 2 may support reservation of sidelink resources at least for blind retransmission.

Procedures related to sensing and resource (re)selection may be supported in sidelink resource allocation mode 2. The sensing procedure may be defined as decoding the SCI from other terminals and/or sidelink measurements. Decoding the SCI in the sensing procedure may provide at least information about the sidelink resources indicated by the terminal transmitting the SCI. When the SCI is decoded, the sensing procedure may use L1 SL RSRP measurement based on SL DMRS. The resource (re)selection procedure may use the results of the sensing procedure to determine resources for sidelink transmission.

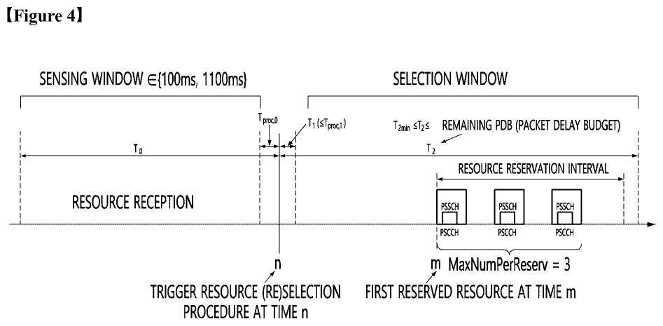

As illustrated in FIG. 4, a method in which transmission resources of the next packet are also reserved may be used for selection of transmission resources.

Referring to FIG. 2B, in sidelink resource allocation mode 2, the terminal may automatically schedule resources. More specifically, the terminal may perform a sidelink operation after automatically selecting a resource within a selection window through a sensing/SCI decoding process. After terminal 1 transmits the SCI to terminal 2 through the PSCCH (S240), data based on the SCI may be transmitted through the PSSCH (S250).

In sidelink resource allocation mode 2, the terminal may receive a resource selection mechanism allowed through the higher layer signaling, and may select a resource to perform the sidelink operation.

The higher layer signaling is the SL-PBPS-CPS-Config information element (IE), which indicates operational information for the resource pool that may be configured to enable full sensing only, partial sensing only, random resource selection only, or any combination(s) thereof.

The sl-AllowedResourceSelectionConfig parameter included in the higher layer signaling indicates the allowed resource selection mechanisms. In other words, the resource selection mechanism may be any one of full sensing only, partial sensing only, random resource selection only, or any combination(s) thereof.

FIG. 4 is a diagram illustrating an example of sidelink resource allocation mode 2 to which the method proposed in the present specification may be applied.

Referring to FIG. 4, when resources are selected for initial transmission, resources for retransmission may be reserved at regular time intervals. The terminal may grasp transmission resources reserved by other terminals or resources being used by other terminals through sensing within a sensing window, and may randomly select a resource with less interference from among the remaining resources after excluding the same within the selection window.

For example, the terminal may decode the PSCCH including information about the period of reserved resources within the sensing window, and measure a PSSCH RSRP on resources periodically determined based on the PSCCH. The terminal may exclude resources for which the PSSCH RSRP value exceeds a threshold value within the selection window. Thereafter, the terminal may randomly select a sidelink resource from the remaining resources within the selection window.

In addition, the terminal may measure a received signal strength indication (RSSI) of periodic resources within the sensing window to determine resources with less interference (for example, the lower 20% of the resources). In addition, the terminal may also randomly select a sidelink resource from the resources included in the selection window among the periodic resources. For example, in case the terminal fails to perform decoding of the PSCCH, the terminal may use the aforementioned methods.

SL-SensingWindow is defined by the internal parameter To and is defined as the number of slots corresponding to SL-SensingWindow msec.

Hereinafter, a method for transmitting channel state information between devices proposed in the present specification will be described in detail with reference to related drawings.

Two or more devices may transmit and receive data through a sidelink, and unless otherwise specified, a transmission device may be a device that transmits data to another device through a sidelink, and a reception device may be a device that operates under control from the transmission device. The transmission device may be referred to as a first device and the reception device as a second device, as needed, and the first device and the second device may be referred to as the reception device and the transmission device, respectively. Although the present specification explains measuring and reporting channel information as an example, it is to be clarified that the contents proposed in the present specification may be applied to any method in which the transmission device requests specific information from the reception device and the reception device reports the same.

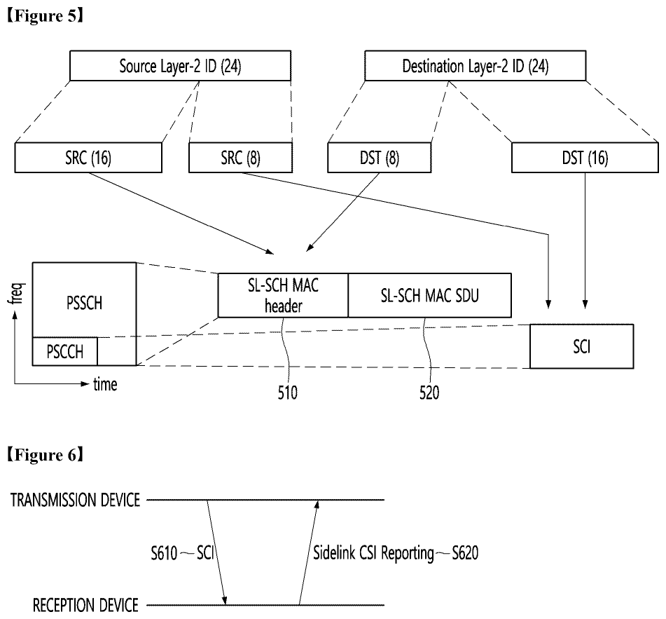

FIG. 5 is a diagram illustrating an example of a control channel and a data channel in a sidelink to which the method proposed in the present specification may be applied.

The control channel in the sidelink is expressed as the PSCCH, and the data channel is expressed as the PSSCH.

Referring to FIG. 5, the PSCCH transmits resource allocation information (SCI, sidelink control information) for data transmission, and the PSSCH transmits actual data (SL-SCH MAC SDU, 520) and a header (SL-SCH MAC header, 510).

The SCI may be transmitted on the PSSCH as well as on the PSCCH. When the SCI is transmitted on the PSCCH, the SCI may be in a 1st stage SCI format and may be expressed in SCI format 1-A. The SCI format 1-A is used for scheduling 2nd stage SCI on the PSSCH and the PSSCH.

In addition, when the SCI is transmitted on the PSSCH, the SCI may be in a 2nd stage SCI format and may be expressed in SCI formats 2-A to 2-C. The 2nd stage SCI format may include a CSI request field.

Next, a method for reporting results of CSI measurements on the sidelink, in other words, CSI reporting, will be described.

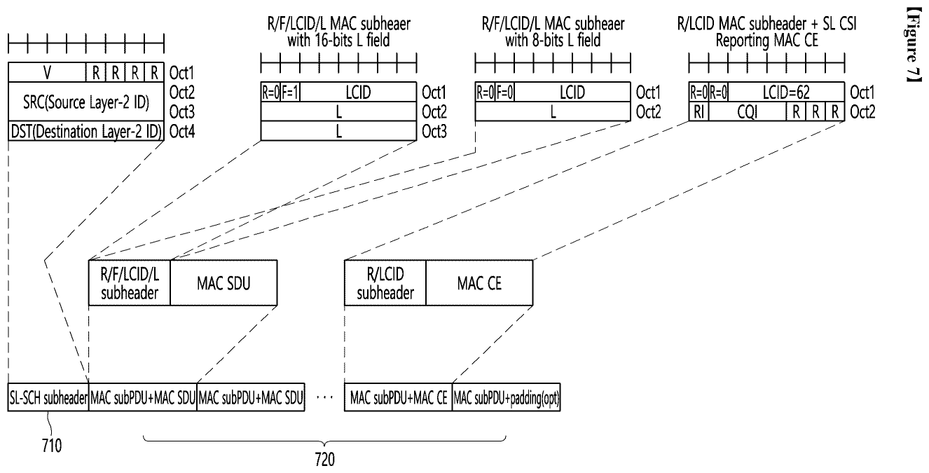

FIG. 6 illustrates an example of a sidelink CSI reporting method to which the method proposed in the present specification may be applied. FIG. 7 illustrates an example of a SL-SCH subheader, MAC subPDU, and MAC CE structure within a PSSCH to which the method proposed in the present specification may be applied.

Referring to FIG. 6, the transmission device and the reception device may measure a channel state for data transmission. Herein, the transmission device transmits a CSI-RS on the PSSCH for the reception device to measure the channel state information (CSI) for the sidelink and report the CSI.

More specifically, the CSI reporting is activated by the higher layer parameter sl-CSI-Acquisition, and the ‘CSI request’ field of SCI format 2-A is configured to 1.

The sl-CSI-Acquisition field is included in SIB 12 and indicates whether the CSI reporting is possible in sidelink unicast. When the fields are not configured, SL CSI reporting is not possible.

The transmission device and reception device may receive a parameter indicating whether the CSI reporting is possible through the higher layer signaling and identify whether the CSI reporting is possible. When the CSI reporting is possible, the transmission device requests the CSI reporting by transmitting the SCI with the CSI request field configured to 1 on the PSSCH to the reception device.

In other words, when the transmission device transmits the SCI with the CSI request field configured to ‘1’ to the reception device (S610), the reception device performs the CSI reporting to the transmission device (S620).

The reception device measures the channel state of the sidelink based on the CSI-RS transmitted on the PSSCH, and includes the measured channel state result, in other words, the CSI reporting, in the sidelink MAC CE (SL CSI Reporting MAC CE, see FIG. 7) and transmits the same to the transmission device.

In this connection, the reception device may perform sidelink CSI reporting to the transmission device from a CSI reference resource. In the frequency domain, the CSI reference resource is defined by a group of sidelink physical resource blocks including sidelink CSI-RSs associated with the derived CSI. In the time domain, the CSI reference resource for the CSI reporting in sidelink slot n is defined by a single sidelink slot nCSI_ref, where nCSI_ref is the same sidelink slot as the corresponding CSI request.

As seen, the SL CSI reporting that the reception device transmits to the transmission device is included in the MAC CE included in the data to be transmitted to the transmission device. However, there may be cases where the reception device has no data to transmit to the transmission device or the SL CSI reporting on the channel measurement results for the CSI-RS may not be transmitted to the transmission device. A method for resolving the same will be described later.

Referring to FIG. 7, a MAC PDU for a SL-SCH (sidelink shared channel) consists of one SL-SCH subheader 710 and one or more MAC subPDUs 720. Each MAC subPDU consists of (1) only MAC subheader (including a padding), (2) MAC subheader and MAC SDU, (3) MAC subheader and MAC CE, and (4) MAC subheader and padding.

The MAC SDU has a variable size, and each MAC subheader except the SL-SCH subheaders corresponds to a MAC SDU, MAC CE, or padding.

The SL-SCH subheader has a fixed size and consists of seven header fields: V/R/R/R/R/SRC/DST. Herein, the SRC represents a source and DST represents a destination.

The MAC subheader, excluding the fixed-size MAC CE and padding, consists of four header fields R/F/LCID/L as illustrated in FIG. 7. The MAC subheader for the fixed-size MAC CE and padding consists of two header fields R/LCID as illustrated in FIG. 7.

SL MAC subPDU(s) with the MAC SDU are disposed after the SL-SCH subheader in the MAC PDU and before the MAC PDU with the padding and the MAC subPDU with the MAC CE, as illustrated in FIG. 7. The SL MAC subPDU with the MAC CE is disposed after all MAC subPDU(s) with the MAC SDU in the MAC PDU and before the MAC subPDU with the padding, as illustrated in FIG. 7. The size of the padding may be 0.

The MAC subheader for the SL-SCH consists of the following fields:
V: The MAC PDU format version number field indicates which version of the SL-SCH subheader is used. The V field is configured to 0, and the size of the V field is 4 bits.

For example, the V may be configured to ‘0001.’ For groupcast, the V may be configured to ‘0010,’ and for broadcast, the V may be configured to ‘0011.’
SRC: The SRC field carries the 16 most significant bits (MSBs) of the Source Layer-2 ID, which is configured to an identifier provided by a higher layer. The SRC field is 16 bits long.
DST: The DST field carries the 8 most significant bits (MSBs) of the Destination Layer-2 ID, which is configured to an identifier provided by a higher layer. The DST field is 8 bits long.
LCD: The logical channel ID field identifies the logical channel instance of the corresponding MAC SDU or the type of the corresponding MAC CE within the scope of one Source Layer-2 ID and Destination Layer-2 ID pair or padding. There is one LCID field per MAC subheader, excluding the SL-SCH subheader. The size of the LCID field is 6 bits.
L: The Length field indicates the length of the corresponding MAC SDU or MAC CE of variable size in bytes. There is one L field per MAC subheader, excluding the SL-SCH subheader and any subheaders corresponding to the fixed-size MAC CE or padding. The size of the L field is indicated by the F field.
F: The Format field indicates the size of the Length field. There is one F field per MAC PDU subheader, excluding the SL-SCH subheader and any subheaders corresponding to the fixed-size MAC CE or padding. The size of the F field is 1 bit. A value of 0 represents 8 bits of the length field, and a value of 1 represents 16 bits of the length field.
R: Reserved bit, configured to 0.

The MAC subheader is octet aligned.

Table 1 below shows examples of LCID values for SL-SCH.

TABLE 1

| Index | LCID values |
|---|---|
| 0 | PC5-S messages (not protected) |
| 1 | PC5-S messages (“Direct Security Mode Command” and “Direct |
| | Security Mode Complete”) |
| 2 | PC5-S messages (protected) |
| 3 | PC5-RRC messages |
| 4-19 | Identity of the logical channel |
| 62 | Sidelink CSI Reporting |

### First Embodiment

The first embodiment relates to a method for processing CSI reporting when there is no data to be transmitted from the reception device at a time point at which the reception device performs the CSI reporting in the sidelink.

First, when there is data to transmit to the transmission device at a time point at which the reception device wishes to transmit the CSI reporting to the transmission device, the reception device reports the CSI reporting by including the same in the MAC CE of the sidelink. In other words, the reception device transmits the MAC CE and MAC SDU including the CSI reporting to the transmission device.

Next, when there is no data to be transmitted to the transmission device at a time point at which the reception device wishes to transmit the CSI reporting to the transmission device, the reception device may perform at least one of the following methods.

### Method 1

Method 1 is a method of transmitting only the MAC CE including the SL CSI reporting.

### Method 2

Method 2 is a method of transmitting the MAC CE and the MAC SDU including the SL CSI reporting by adding the padding.

### Method 3

Method 3 is a method that does not transmit the SL CSI reporting.

Methods 1 to 3 described above will be applied to the sidelink resource allocation modes illustrated in FIGS. 2 to 4, respectively.

First, a method of applying Methods 1 to 3 in sidelink resource allocation mode 1 will be described.

The reception device that receives an SL Grant, in other words, the SCI, from the transmission device transmits data on the PSSCH based on the received SCI. However, when there is no data to be transmitted from the reception device to the transmission device (or the base station), the reception device may transmit only the SL CSI reporting to the transmission device. More specifically, the reception device may transmit a MAC PDU including only a MAC CE including the CSI reporting without including a MAC SDU, or may transmit the MAC PDU including the MAC CE including the MAC SDU and the CSI reporting to the transmission device, provided that the MAC SDU is padded by a predetermined size (for example, a minimum PSSCH size) because the MAC SDU has no data to transmit.

Alternatively, when the reception device has no data to transmit to the transmission device (or base station), the reception device may not transmit the SL CSI reporting, or may transmit the SL CSI reporting only when actual data is generated and data is to be transmitted to the transmission device (or the base station).

Next, a method of applying Methods 1 to 3 in sidelink resource allocation mode 2 will be described.

As in sidelink resource allocation mode 1 described above, when the reception device receives a request to report channel measurement information from the transmission device, in other words, when the reception device receives the SCI with the CSI request field configured to ‘1,’ the reception device senses a channel for data transmission and transmits data. However, when the reception device has no data to transmit to the transmission device (or base station), the reception device may transmit only the SL CSI reporting to the transmission device. More specifically, the reception device may transmit a MAC PDU including only a MAC CE including the CSI reporting without including a MAC SDU, or may transmit the MAC PDU including the MAC CE including the MAC SDU and the CSI reporting to the transmission device, provided that the MAC SDU is padded by a predetermined size (for example, a minimum PSSCH size) because the MAC SDU has no data to transmit.

In addition, the reception device needs to sense the channel for data transmission and transmit data, but when there is no data to transmit to the transmission device (or base station), the reception device may not transmit the SL CSI reporting, or may transmit the SL CSI reporting only when actual data is generated and data is to be transmitted to the transmission device (or base station). In other words, the reception device may avoid unnecessary sensing, thereby reducing power consumption.

Alternatively, the reception device may perform sensing and retry once or a predetermined number of times or within a predetermined time period, and transmit the CSI reporting when the selected channel has resources available to transmit the SL CSI reporting.

### Second Embodiment

The second embodiment relates to a method for defining priorities for data in a sidelink and retransmitting the CSI reporting.

When data including the MAC SDU is received from the transmission device, the reception device transmits a data reception result (for example, HARQ feedback) to the transmission device. In addition, the reception device determines whether to retransmit the data transmitted to the transmission device, and performs retransmission to the transmission device when retransmission is necessary. However, for data that does not require CSI reporting or HARQ feedback, the reception device does not transmit the reception result to the transmission device.

In addition, sidelink logical channels are defined differently for cases with and without SL CSI Report MAC CE, and the sidelink logical channels are prioritized in the following order: (1) SCCH data (data from SCCH), (2) SL CSI Reporting MAC CE, and (3) any STCH data (data from any STCH). The SCCH data has the highest priority.

However, since the priority is not defined for cases where the Sidelink CSI Reporting MAC CE and any STCH data are transmitted together, it is necessary to redefine the priority therefor.

Hereinafter, the priority when the Sidelink CSI Reporting MAC CE and any STCH data are transmitted together will be described.

### Method 1

Method 1 is a method of defining the priority in the case where the Sidelink CSI Reporting MAC CE and any STCH data are transmitted together as the same as the priority of the Sidelink CSI Reporting MAC CE or the priority of STCH data.

### Method 2

Method 2 is a method of defining a third priority between the priorities of the Sidelink CSI Reporting MAC CE and any STCH data when the Sidelink CSI Reporting MAC CE and any STCH data are transmitted together.

As described above, since the Sidelink CSI Reporting MAC CE does not require HARQ feedback, the transmission device may determine retransmission based on a result of any STCH data transmission (in other words, HARQ feedback transmitted by the reception device).

In this connection, since the reception device may not know whether the previously transmitted Sidelink CSI Reporting MAC CE has been properly transmitted to the transmission device, the reception device may transmit the Sidelink CSI Reporting MAC CE and MAC SDU together, or transmit only the MAC SDU (excluding the Sidelink CSI Reporting MAC CE) to the transmission device.

Alternatively, when a condition requiring the Sidelink CSI Reporting MAC CE to be transmitted to the transmission device is satisfied (for example, before a certain time has elapsed or within a certain number of times), the reception device may retransmit the Sidelink CSI Reporting MAC CE by including the same in the MAC SDU transmission (in other words, transmitting the CSI Reporting MAC CE and MAC SDU together).

Alternatively, the transmission device may re-request the Sidelink CSI Report MAC CE request in the HARQ feedback, similar to when the transmission device requests the Sidelink CSI Reporting MAC CE to the reception device.

In response, the reception device may transmit the Sidelink CSI Reporting MAC CE and MAC SDU together as described above, may transmit only the Sidelink CSI Reporting MAC CE, or may transmit only the MAC SDU (excluding the Sidelink CSI Reporting MAC CE) to the transmission device.

In this connection, as explained above, the priority of the logical channel may be kept the same as the previous transmission (for example, the initial transmission) for scheduling purposes. Alternatively, the priority may be reconfigured depending on the form of retransmission (for example, transmit the Sidelink CSI Reporting MAC CE and MAC SDU together, transmit Sidelink CSI Reporting MAC CE only, or transmit MAC SDU only).

### Third Embodiment

The third embodiment relates to a method for selecting a channel (or resource) for data transmission between devices using a preferred or non-preferred resource set defined in sidelink resource allocation mode 2.

Hereinafter, UE-A is expressed as a terminal that provides sidelink resource set (or group or set) information to another device, and UE-B is expressed as a terminal that receives the sidelink resource set information from the UE-A and determines resources for data transmission.

As previously described in FIG. 4, in sidelink resource allocation mode 2, the data transmission method through resource sensing of the transmission device performs sensing in a given sensing window for a predetermined time (for example, 1100 ms for aperiodic traffic, 100 ms for periodic traffic). However, in this connection, there is an issue that the power consumption of a device is high because the transmission device needs to sense all channels (or resources). To address this issue, partial sensing or random sensing, which senses only some channels, may be applied. In particular, when one device (for example, UE-A) transmits a selected resource group to another device (for example, UE-B) so that UE-B selects a resource from the resource group received from the UE-A, the delay due to channel sensing may be reduced.

In addition to the power consumption issues mentioned above, inter-UE coordination operations may be performed to address hidden node issues, exposed node issues, and half-duplex operation issues.

The inter-UE coordination operation is triggered by higher layer signaling. When the operation is triggered, the base station provides a resource pool from which preferred or non-preferred resources are to be determined, a resource selection window within which preferred or non-preferred resources are to be determined, a resource set type (preferred or non-preferred resource set), etc.

When the inter-UE coordination operation is supported, the UE-A may transmit the sidelink resource set information to the UE-B, and the UE-B may perform resource sensing operation and/or resource selection operation considering the sidelink resource set information. Alternatively, the UE-B may perform resource sensing operation and/or resource selection operation without considering the sidelink resource set information. The sidelink resource set information may be referred to as coordination information. The sidelink resource set information may include preferred resource information and/or not-preferred resource information for UE-B transmission.

The determination of whether a resource set is preferred or non-preferred may be indicated by the resource set type field included in SCI Format 2-C. In other words, when the resource set type field is configured to ‘0’, it indicates a preferred resource set, and when the resource set type field is configured to ‘1’, it indicates a non-preferred resource set.

When a plurality of UE-As transmits the same channel (or resource) to the UE-B as a recommended channel (or preferred resource), the corresponding terminals expect the UE-B to transmit data through the corresponding channel, and thus attempt to receive (decode) data through the channel. Alternatively, non-recommended channels (or non-preferred resources) are excluded from channel selection. However, when one device recommends the corresponding channel, only the corresponding terminal may monitor the channel. Then other devices may prevent unnecessary decoding. In other words, the UE-B may use the channel recommended by the least number of terminals for data transmission instead of using the channel recommended by multiple devices for data transmission.

When data is transmitted or broadcasted to a UE group, data may be transmitted by selecting the channel with the largest number of UEs reporting a specific channel as a recommended channel, or by selecting the channel with the smallest number of UEs reporting a non-recommended channel.

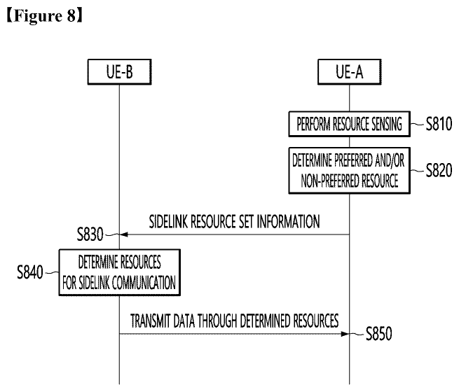

FIG. 8 is a flowchart showing an example of a method for selecting resources for data transmission in a sidelink proposed in the present specification.

Referring to FIG. 8, at least one UE-A each performs a resource sensing operation (S810). The at least one UE-A may include a first UE-A, a second UE-A, etc.

In addition, the at least one UE-A determines a recommended resource (for example, a preferred resource) and/or a non-recommended resource (for example, a non-preferred resource) based on a result of the resource sensing operation (S820). Herein, the resource may mean a set of resources. The at least one UE-A may generate the sidelink resource set information including preferred resource information and/or non-preferred resource information, and transmit the generated sidelink resource set information to the UE-B (S830).

Herein, the sidelink resource set information may include all or part of the information elements acquired by the resource sensing operation. The sidelink resource set information may include time resource information and/or frequency resource information.

In addition, the at least one UE-A may transmit to the UE-B not only the sidelink resource set information but also information necessary for resource determination (or allocation or selection) in the UE-B and/or information helpful for resource determination.

In addition, the UE-B receives the sidelink resource set information from the at least one UE-A.

Then, the UE-B determines resources for data transmission with or without considering the sidelink resource set information (S840).

The determined resource may be a preferred resource transmitted by multiple UE-As, or a preferred resource transmitted by the least number of UE-As.

In addition, when the data to be transmitted by the UE-B is data to be transmitted to the UE group or broadcast data, the determined resource may be a preferred resource transmitted by the multiple UE-As or a non-preferred resource transmitted by the least number of UE-As.

In addition, the UE-B transmits data through the determined resource (S850).

The first to third embodiments described above may be implemented and performed separately in a terminal, or at least one of the first to third embodiments may be combined and implemented and performed in the terminal.

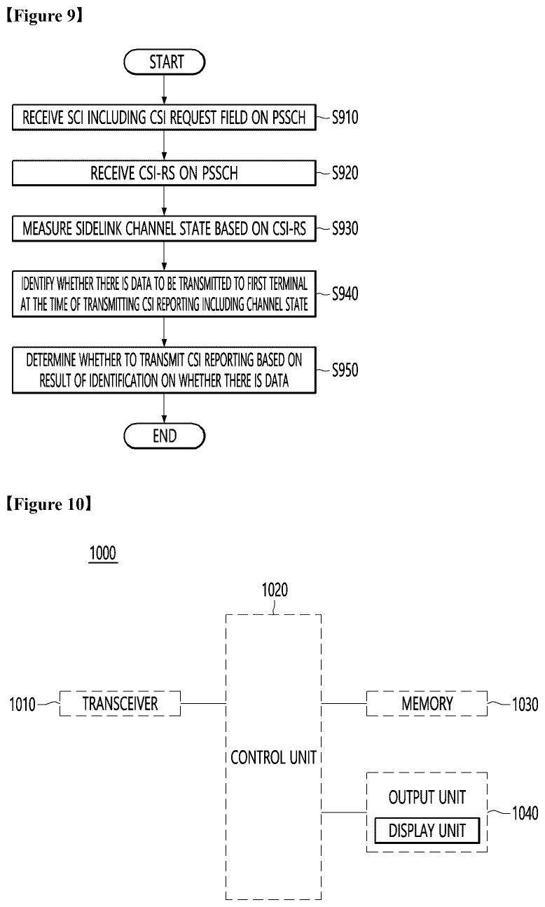

FIG. 9 is a flowchart showing an example of an operation method of a terminal for performing the method proposed in the present specification.

In other words, FIG. 9 relates to a method for transmitting or receiving data between a first terminal and a second terminal through a sidelink in a wireless communication system.

The second terminal receives the SCI including the CSI request field indicating the CSI request from the first terminal on the PSSCH (S910).

In addition, the second terminal receives the CSI-RS from the first terminal on the PSSCH (S920).

In addition, the second terminal measures the channel state for the sidelink based on the received CSI-RS (S930).

In addition, the second terminal identifies whether there is data to be transmitted to the first terminal at the time of transmitting the CSI reporting including the measured channel state (S940).

In addition, the second terminal determines whether to transmit the CSI reporting based on a result of the identification (S950).

In stage S950, when there is data to be transmitted to the first terminal, the second terminal may transmit, to the first terminal, the MAC PDU (protocol data unit) including the MAC CE (control element) including the CSI reporting and the MAC SDU (service data unit) including data to be transmitted to the first terminal.

In stage S950, when there is no data to be transmitted to the first terminal, the MAC PDU including the MAC CE including the CSI reporting may be transmitted to the first terminal. Herein, the MAC PDU does not include the MAC SDU including data.

In stage S950, when there is no data to be transmitted to the first terminal, the second terminal may transmit the MAC PDU including the MAC CE including the CSI reporting and the MAC SDU padded to a certain size to the first terminal. The certain size may be the minimum size of the PSSCH.

In stage S950, when there is no data to be transmitted to the first terminal, the second terminal may not transmit the CSI reporting to the first terminal.

In stages S910 to S950, the second terminal may receive higher layer signaling from the base station that triggers the inter-UE coordination operation.

Herein, the higher layer signaling may include control information related to determining a preferred or non-preferred resource set.

In addition, the second terminal may perform resource sensing based on the higher layer signaling, determine a sidelink resource set including at least one of a preferred resource set and a non-preferred resource set based on a result of the resource sensing, transmit information related to the determined sidelink resource set to the first terminal, and receive data on the PSSCH from the first terminal through a sidelink resource.

The sidelink resource may be a preferred resource transmitted by multiple terminals or a preferred resource transmitted by a small number of terminals.

Data received on the PSSCH through the sidelink resource may be groupcast data transmitted to a group of terminals or broadcast data transmitted to a plurality of terminals.

Alternatively, the sidelink resource may be a preferred resource transmitted by the multiple terminals or a non-preferred resource transmitted by a small number of terminals.

In addition, the second terminal may receive a retransmission request for the CSI reporting from the first terminal and perform retransmission related to the CSI reporting to the first terminal.

The retransmission related to the CSI reporting may be transmission of the MAC PDU including the MAC CE and the MAC SDU including the CSI reporting, transmission of the MAC PDU including the MAC CE including the CSI reporting but not including the MAC SDU, or transmission of the MAC PDU including the MAC SDU but not including the MAC CE including the CSI reporting. For a more detailed explanation thereof, please refer to the second embodiment described above.

The terminal operation method of FIG. 9 described above may be implemented by a terminal including a radio frequency (RF) module for transmitting or receiving a wireless signal and a processor functionally connected to the RF module.

More specifically, the processor included in the second terminal may be controlled to: receive sidelink control information (SCI) including a channel state information (CSI) request field indicating a CSI request from the first terminal on a physical sidelink shared channel (PSSCH); receive a CSI-RS from the first terminal on the PSSCH; measure a channel state of the sidelink on the basis of the received CSI-RS; identify whether there is data to be transmitted to the first terminal at a time point at which CSI reporting including the measured channel state is to be transmitted; and determine whether to transmit the CSI reporting on the basis of a result of the identification.

FIG. 10 shows an example of an internal block diagram of the device proposed in the present specification.

A device 1000 for implementing a method or a function proposed in the present specification may include a control unit (or processor) 1020, a storage unit (temporary or non-temporary storage device) (or memory) 1030, a bus (not illustrated) for data transmission or a transceiver 1010 for performing communication with the outside, and an output unit 1040.

Herein, the device includes all devices mentioned in the present specification, and may include terminals, UEs, base stations, etc.

The storage may include magnetic storage media or flash storage media, but the scope of the present disclosure is not limited thereto.

The transceiver may consist of wired and/or wireless communication modules. For example, the transceiver may include wireless communication modules such as wireless fidelity (Wi-Fi), Bluetooth, Zigbee, near field communication (NFC), Wireless Broadband Internet (Wibro), 3G, 4G, 5G, and 6G, and wired communication modules such as wired LAN such as Ethernet. The transceiver may perform wired/wireless communication with user devices through a network.

When the transceiver is a wireless transceiver, it may be called an RF module and may include an antenna for transmitting or receiving wireless signals.

The control unit may include any type of device capable of processing data, such as a processor. Herein, the term “processor” may refer to a data processing device built in hardware, which includes physically structured circuits in order to perform functions represented as a code or command present in a program. Examples of the data processing device built in hardware may include microprocessors, central processors (CPUs), processor cores, multiprocessors, application-specific integrated circuits (ASICs), and field programmable gate array (FPGA), but the scope of the present disclosure is not limited thereto.

The output unit is intended to generate an output related to a visual, aural, or tactile stimulus, and may include at least one of a display unit, a sound output unit, a haptic module, and an optical output unit. The display unit may implement a touchscreen by forming a layered structure or being integrated with touch sensors. The touchscreen may not only function as a user input unit for providing an input interface between the device and a user but also provide an output interface between the device and the user.

The embodiments described so far are those of the elements and features of the present disclosure being coupled in a predetermined form. So far as there is not any apparent mention, each of the elements and features should be considered to be selective. Each of the elements and features may be embodied without being coupled with other elements or features. In addition, it is also possible to construct the embodiments of the present disclosure by coupling a part of the elements and/or features. The order of operations described in the embodiments of the present disclosure may be changed. A part of elements or features in an embodiment may be included in another embodiment, or may be replaced by the elements and features that correspond to other embodiment. It is apparent to construct embodiment by combining claims that do not have explicit reference relation in the following claims, or to include the claims in a new claim set by an amendment after application.

The embodiments of the present disclosure may be implemented by various means, for example, hardware, firmware, software and the combination thereof. In the case of the implementation by the hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), a processor, a controller, a micro controller, a micro processor, and the like.

In the case of the implementation by the firmware or the software, an embodiment of the present disclosure may be implemented in a form such as a module, a procedure, a function, and so on that performs the functions or operations described so far. Software codes may be stored in the memory, and driven by the processor. The memory may be located interior or exterior to the processor, and may exchange data with the processor with various known means.

It will be understood to those skilled in the art that various modifications and variations may be made without departing from the essential features of the present disclosure. Therefore, the detailed description is not limited to the embodiments described above, but should be considered as examples. The scope of the present disclosure should be determined by reasonable interpretation of the attached claims, and all modification within the scope of equivalence should be included in the scope of the present disclosure.

### INDUSTRIAL APPLICABILITY

A method for transmitting or receiving data through a sidelink in a wireless communication system of an embodiment of the present disclosure has been described with reference to the examples applied to 3GPP LTE/LTE-A systems and 5G systems (New RAT systems), but may also be applied to various other wireless communication systems.

What is claimed is:

1. A method for transmitting or receiving data between a first terminal and a second terminal through a sidelink in a wireless communication system, the method performed by the second terminal comprising:
receiving sidelink control information (SCI) including a channel state information (CSI) request field indicating a CSI request from the first terminal on a physical sidelink shared channel (PSSCH);
receiving a CSI-RS from the first terminal on the PSSCH;
measuring a channel state of the sidelink based on the received CSI-RS;
checking whether there is data to be transmitted to the first terminal at a time point at which CSI reporting including the measured channel state is to be transmitted; and
determining whether to transmit the CSI reporting based on a result of the identification.

2. The method of claim 1, further comprising transmitting, to the first terminal, a MAC protocol data unit (PDU) including a MAC control element (CE) including the CSI reporting and a MAC service data unit (SDU) including data to be transmitted to the first terminal, when there is data to be transmitted to the first terminal.

3. The method of claim 1, wherein, when there is no data to be transmitted to the first terminal, the MAC PDU including the MAC CE including the CSI reporting is transmitted to the first terminal, but the MAC PDU does not include the MAC SDU including the data.

4. The method of claim 1, further comprising transmitting, to the first terminal, a MAC protocol data unit (PDU) including a MAC control element (CE) including the CSI reporting and a MAC service data unit (SDU) padded to a certain size, when there is no data to be transmitted to the first terminal.

5. The method of claim 4, wherein the certain size is a size of the PSSCH.

6. The method of claim 1, wherein, when there is no data to be transmitted to the first terminal, the CSI reporting is not transmitted to the first terminal.

7. The method of claim 1, further comprising receiving higher layer signaling that triggers an inter-UE coordination operation from a base station, wherein the higher layer signaling includes control information related to determination of a preferred or non-preferred resource set.

8. The method of claim 7, further comprising:
performing resource sensing based on the higher layer signaling;
determining a sidelink resource set including at least one of a preferred resource set or a non-preferred resource set based on a result of the resource sensing;
transmitting information related to the determined sidelink resource set to the first terminal; and
receiving the data on the PSSCH through a sidelink resource from the first terminal.

9. The method of claim 8, wherein the sidelink resource is a preferred resource transmitted by multiple terminals or a preferred resource transmitted by a small number of terminals.

10. The method of claim 8, wherein the data received on the PSSCH through the sidelink resource is groupcast data transmitted to a terminal group or broadcast data transmitted to a plurality of terminals.

11. The method of claim 10, wherein the sidelink resource is a preferred resource transmitted by multiple terminals or a non-preferred resource transmitted by a small number of terminals.

12. The method of claim 1, further comprising:
receiving a retransmission request for the CSI reporting from the first terminal; and
performing retransmission related to the CSI reporting to the first terminal.

13. The method of claim 12, wherein the retransmission related to the CSI reporting is configured to:
transmit a MAC PDU including a MAC CE and a MAC SDU including the CSI reporting;
transmit the MAC PDU including the MAC CE including the CSI reporting but not including the MAC SDU; or
transmit the MAC PDU including the MAC SDU but not including the MAC CE including the CSI reporting.

14. A method for transmitting or receiving data between a first terminal and a second terminal through a sidelink in a wireless communication system,
wherein the second terminal comprises:
a radio frequency (RF) module for transmitting or receiving a radio signal; and
a processor functionally connected to the RF module, and
wherein the processor is controlled to:
receive sidelink control information (SCI) including a channel state information (CSI) request field indicating a CSI request from the first terminal on a physical sidelink shared channel (PSSCH);
receive a CSI-RS from the first terminal on the PSSCH;
measure a channel state of the sidelink based on the received CSI-RS;
check whether there is data to be transmitted to the first terminal at a time point at which CSI reporting including the measured channel state is to be transmitted; and
determine whether to transmit the CSI reporting based on a result of the identification.
